(19) United States
(12) Patent Application Publication
(10) Pub. No.: US 2003/0122425 A1
(43) Pub. Date: Jul. 3, 2003

(54) Track shoe isolator

(76) Inventor: Bappaditya Banerjee, Peoria, IL (US)

Correspondence Address: Finnegan, Henderson, Farabow,, Garrett & Dunner, L.L.P., 1300 I Street, N.W., Washington, DC, 20005-3315, US

(21) Appl. No.: 10/026,731

(22) Filed: Dec. 27, 2001

(51) Int. Cl. B62D 55/12

(52) U.S. Cl. 305/201

(57) ABSTRACT

A track assembly for a track-type machine includes a link assembly having a plurality of interconnected link sets forming an oval track path, a plurality of track shoes, each being coupled to a respective link set, and at least one isolation plate located between a track shoe and its respective link set. The isolation plate acts to reduce the amount of undercarriage impact energy traveling to the track shoes and radiated as noise.

### TECHNICAL FIELD

This invention relates to a device for reducing the noises emanating from an undercarriage of a track-type machine during operation.

### BACKGROUND

Conventional track-type machines emit operational noises that are often considered objectionable to individuals in the vicinity of the machine. The disturbance associated with such noise is compounded by the fact that track-type machines are often operated in places of high human population, such as near office buildings or apartment complexes.

A portion of the noise created by track-type machines can be attributed to the metal-to-metal impacts of the undercarriage of the machine during operation. For example, noises are caused by metal-to-metal impacts between the teeth of the drive sprocket and the bushings interconnecting the links of a link assembly, between the surfaces of the idler roller and the links, and between the rolling surface of the carrier rollers and the links. The energy of these impacts is transferred from the point of impact to the link assembly, and then from the link assembly to the track shoes of the track assembly. This energy is then radiated from the track shoe as noise.

Many attempts have been proposed to reduce the noises created by the undercarriage of track-type machines. For example, U.S. Pat. No. 4,099,796 to Groff discloses a track assembly including track shoes having a cover plate and viscoelastic material affixed to an inner, link-side surface of the track shoes. The viscoelastic material is located outside the area of coupling of the link assembly and the track shoes. The cover plate and viscoelastic material act to reduce the noise of the undercarriage of the track-type machine by dissipating and absorbing vibrations of the track shoe during operation. This attempt at reducing the vibrational noise of the undercarriage of track-type machines, however, suffers the drawbacks that impact energy can still travel directly through the rigid structures coupling the link assembly to the track shoe.

The present invention provides an apparatus for reducing the noise of an undercarriage of a track-type machine that avoids some or all of the aforesaid shortcomings in the prior art.

### SUMMARY OF THE INVENTION

In accordance with one aspect of the invention, a track assembly for a track-type machine includes a link assembly having a plurality of interconnected link sets forming an oval track path, a plurality of track shoes, each being coupled to a respective link set, and at least one isolation plate located between a track shoe and its respective link set.

According to another aspect of the present invention, a track-type assembly for a track-type machine includes a link assembly including a plurality of interconnected link sets forming an oval track path, a plurality of track shoes, each being coupled to a respective link set, and a plurality of isolation plates, one isolation plate being coupled between each track shoe and respective link set. Each of the isolator plates includes a first cover plate, a second cover plate, and an isolation layer disposed between the first and second cover plates.

According to yet another aspect of the present invention, an isolation plate for a track assembly of a track-type machine includes a first cover plate, a second cover plate coupled to the first cover plate, and an isolation layer disposed between the first and second cover plates.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several exemplary embodiments of the invention and together with the description, serve to explain the principles of the invention.

### BRIEF DESCRIPTION OF THE DRAWINGS

FIG. 1 is a perspective view of a track-type machine incorporating an exemplary embodiment of the present invention;

FIG. 2 is a partial perspective view of the track assembly of FIG. 1;

FIG. 3 is an exploded partial view of the track assembly of FIG. 1; and

FIG. 4 is side perspective view of an isolation plate according to an exemplary embodiment of the present invention.

### DETAILED DESCRIPTION

Reference will now be made in detail to the exemplary embodiments of the invention, examples of which are illustrated in the accompanying drawings. Wherever possible, the same reference numbers will be used throughout the drawings to refer to the same or like parts.

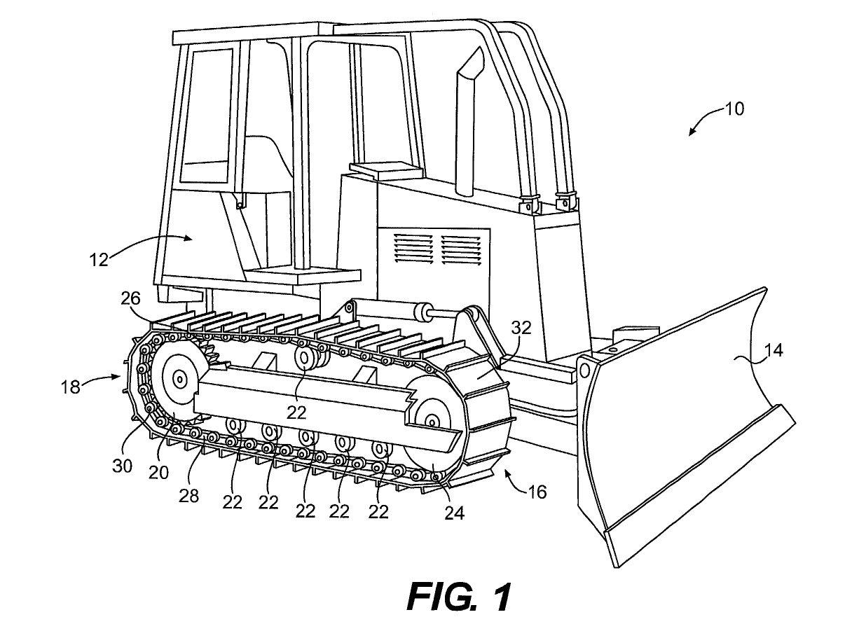

FIG. 1 illustrates a track-type machine 10 incorporating the present invention. Track-type machines as defined herein may include, for example, any machine incorporating a track or crawler-type driving system. Such driving systems are commonly used in earth moving, earth digging, and earth carrying machines. Track-type machine 10 may include a machine body 12, a blade member 14, and an undercarriage 16 having a track assembly 18. Although not shown in FIG. 1, undercarriage 16 of track-type machine 10 may include a second track assembly located on a side of machine body 12 opposite track assembly 18.

FIG. 1 further illustrates the basic components that may be included in an undercarriage 16 of a track-type machine 10 according to an exemplary embodiment of the present invention. For example, undercarriage 16 may include a drive sprocket 20, carrier rollers 22 and an idler roller 24 together forming a generally oval track path for a link assembly 28. Drive sprocket 20 may be rotated by an engine (not shown) of track-type machine 10 causing the teeth 26 of drive sprocket 20 to engage bushings 30 of link assembly 28 to rotate link assembly 28 about the oval track path. Track shoes 32 may be coupled to outer portions of link assembly 28 to form a ground contacting traction surface of track assembly 18.

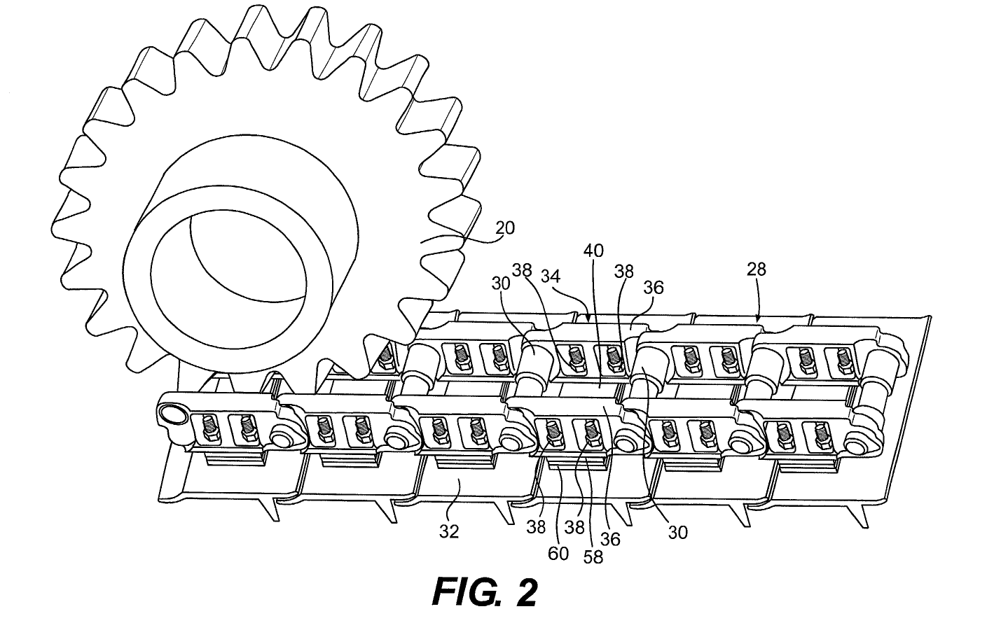

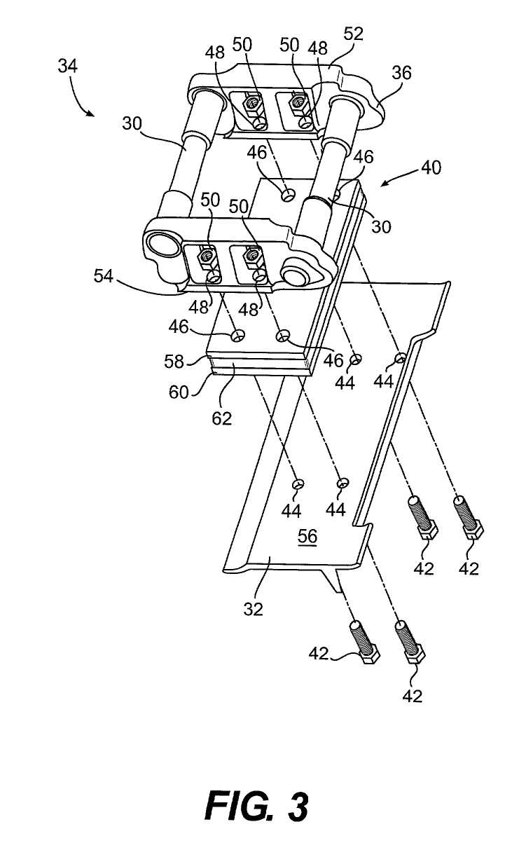

Referring to FIG. 2, link assembly 28 may be formed by a successive set of interconnected link sets 34. Link sets 34 may include two (2) opposing links 36 connected to each other by a pair of bushings 30. Link sets 34 may be coupled to track shoes 32 by a plurality of fasteners 38. As described in more detail below in connection with FIG. 3, an isolation plate 40 may be located between each link set 34 of link assembly 28 and the respective track shoe 32 coupled to link set 34.

FIG. 3 illustrates an exploded view of the connection of a single link set 34, a single isolation plate 40, and a single track shoe 32 in accordance with an exemplary embodiment of the present invention. Four (4) bolts 42 of fasteners 38 may extend through bolt holes 44 of track shoe 32, bolt holes 46 of isolation plate 40, and through bolt holes 48 of link set 34, and be secured by nuts 50 at an inner surface 52 of link set 34. Accordingly, isolation plate 40 may be coupled between the outer surface 54 of link set 34 and an inner surface 56 of track shoe 32.

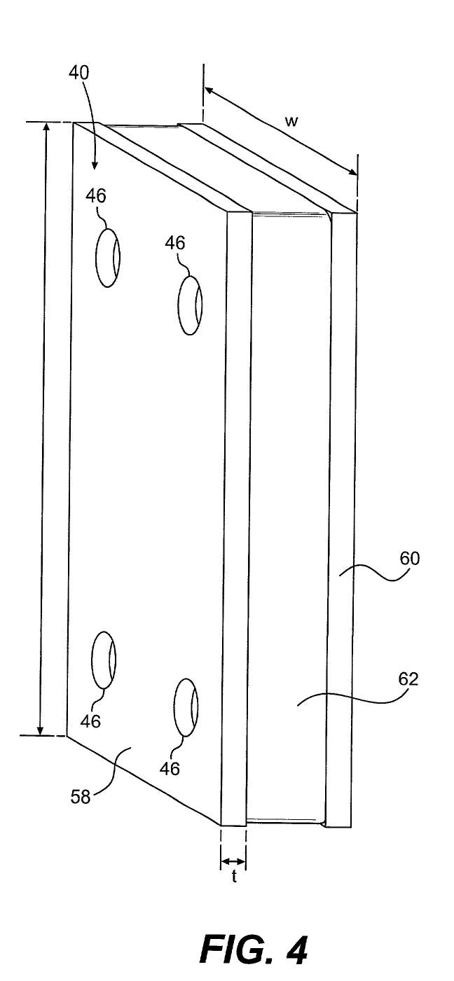

Isolation plate 40 may include two (2) identical cover plates 58, 60 with an isolation layer 62 bonded therebetween. Cover plates 58, 60 may be formed of any appropriately rigid material, for example, steel, and may be formed in any appropriate shape, for example, a generally rectangular shape having a length (l) and width (w) large enough to provide a proper fastening between link set 34 and track shoe 32 via fasteners 38. As illustrated in FIG. 4, cover plates 58, 60 may have a thickness (t) in the range of approximately 0.5 mm (0.02 inches) to 3 mm (0.12 inches). One skilled in the art would understand, however, that all of the dimensions of cover plates 58, 60 will vary depending upon the dimensions of track assembly 18.

Isolation layer 62 may be rectangular in shape and dimensioned to have the same or approximately the same width (w) and length (l) as cover plates 58, 60, and thus include bolt holes extending therethrough. Alternatively, isolation layer 62 may be formed in any other shape depending upon the shape of cover plates 58, 60.

Isolation layer 62 may be formed of any material that ensures a sufficiently rigid connection between track shoes 32 and link sets 34, yet is capable of absorbing impact energy received from the link set 34 or track shoe 32. For example, isolation layer 62 may be formed of hard rubber or soft metal. Examples of appropriate materials forming isolation layer 62 include nylon, neoprene, perforated aluminum, polyvinyl chloride (PVC) and urethane. The thickness of isolation layer 62 may be selected to ensure that isolation plate 40 is capable of carrying a desired percentage of the gross machine weight without large deformations under load. Isolation layer 62 may have a thickness slightly greater than the thickness of one of the cover plates 58, 60, for example, in the range of approximately 1 mm (0.04 inches) to 3.5 mm (0.14 inches).

Industrial Applicability

During operation of track assembly 18 of track-type machine 10, isolation plate 40 acts to reduce the stiffness between the link sets 34 and track shoes 32 and, in effect, isolating or partially isolating each track shoe 32 from each link set 34. Isolation or partial isolation of track shoes 32 from link sets 34 by isolation plate 40 reduces the energy transferred to track shoes 32, and thus reduces the noise radiated therefrom. Accordingly, isolation plate 40 achieves a reduction in impact impedance that results in a quieter undercarriage 16 of track-type machine 10. Isolation plate 40 does not interfere with the interaction of drive sprocket 20 and link assembly 28.

It is contemplated that this cost-effective noise dampening system may have wide applications on all types of track-type machines. This system may be installed on new machines during the manufacturing process or may be retrofitted onto existing machines in the field.

Other embodiments of the invention will be apparent to those skilled in the art from consideration of the specification and practice of the invention disclosed herein. For example, many different alternatives for coupling together link set 34, isolation plate 40, and track shoe 32 are possible in accordance with the present invention. Further, isolation plates 40 may be coupled to all or only a portion of link sets 34 of track assembly 28. Even further, isolation plate 40 may be formed without an outer cover plate 60 so that isolation layer 62 is positioned directly against track shoe 32. In this arrangement track shoe 32 serves the purpose of cover plate 60 described above. It is intended that the specification and examples be considered as exemplary only, with a true scope and spirit of the invention being indicated by the following claims.

What is claimed is:

1. A track assembly for a track-type machine, comprising:
a link assembly including a plurality of interconnected link sets forming an oval track path;
a plurality of track shoes, each being coupled to a respective link set; and
at least one isolation plate located between a track shoe and its respective link set.

2. A track assembly according to claim 1, wherein the at least one isolation plate includes two cover plates and an isolation layer disposed between the two cover plates.

3. A track assembly according to claim 2, wherein each of the cover plates include holes extending therethrough to align with holes extending through said track shoe and respective link set.

4. A track assembly according to claim 3, wherein the holes of the cover plates are bolt holes.

5. A track assembly according to claim 2, wherein the at least one isolation layer is bonded to each of the two cover plates.

6. A track assembly according to claim 2, wherein the isolation layer is disposed within a boundary defined by the two cover plates.

7. A track assembly according to claim 6, wherein the isolation layer is formed in a generally rectangular shape.

8. A track assembly according to claim 2, wherein each of the cover plates are generally rectangular in shape.

9. A track assembly according to claim 2, wherein the isolation layer is formed of one of nylon, neoprene, perforated aluminum, polyvinyl chloride and urethane.

10. A track assembly according to claim 2, wherein each of the cover plates is metal.

11. A track assembly for a track-type machine, comprising:
a link assembly including a plurality of interconnected link sets forming an oval track path;
a plurality of track shoes, each being coupled to a respective link set; and
a plurality of isolation plates, one isolation plate being coupled between each track shoe and respective link set, each of the plurality of isolation plates including a first cover plate, a second cover plate and an isolation layer disposed between the first and second cover plates.

12. A track assembly according to claim 11, wherein the first and second cover plates include holes extending therethrough to align with holes extending through said track shoe and respective link set.

13. A track assembly according to claim 11, wherein the isolation layer is bonded to the first and second cover plates.

14. A track assembly according to claim 11, wherein the isolation layer is disposed within a boundary defined by the first and second cover plates.

15. A track assembly according to claim 11, wherein the isolation layer is formed of one of nylon, neoprene, perforated aluminum, polyvinyl chloride and urethane.

16. An isolation plate for a track assembly of a track-type machine, comprising:
a first cover plate;
a second cover plate coupled to the first cover plate; and
an isolation layer disposed between the first and second cover plates.

17. An isolation plate according to claim 16, wherein the first and second cover plates include holes extending therethrough to align with holes of the track assembly.

18. An isolation plate according to claim 16, wherein the isolation layer is bonded to the first and second cover plates.

19. An isolation plate according to claim 16, wherein the isolation layer is disposed within a boundary defined by the first and second cover plates.

20. An isolation plate according to claim 19, wherein the at least one isolation layer is formed in a generally rectangular shape.

21. An isolation plate according to claim 16, wherein the first and second cover plates are generally rectangular in shape.

22. An isolation plate according to claim 16, wherein the isolation layer is formed of one of nylon, neoprene, perforated aluminum, polyvinyl chloride and urethane.

23. An isolation plate according to claim 16, wherein each of the first and second cover plates is metal.
